(19) United States
(12) Patent Application Publication
(10) Pub. No.: US 2006/0030631 A1
(43) Pub. Date: Feb. 9, 2006

(54) Laser markable polymers

(76) Inventors: Bakhtiar Alam Shah, McMurray, PA (US); Chad R. Tomsheck, Pittsburgh, PA (US); Douglas William Lunz, Moon Township, PA (US)

Correspondence Address: LAURENCE T. PEARSON, 2009 DOGWOOD LANE, WILMINGTON, DE, 19810, US

(21) Appl. No.: 11/049,514

(22) Filed: Feb. 3, 2005

Related U.S. Application Data
(60) Provisional application No. 60/599,069, filed on Aug. 6, 2004.

(51) Int. Cl. C08J 9/00

(52) U.S. Cl. 521/50

(57) ABSTRACT

A polymer composition that is suitable for marking by laser radiation. The composition comprises a foaming agent that is present in a quantity that is not sufficient to induce bulk foamability in the polymer, but enhances the contrast available in the marking process compared to compositions that do not comprise the agent.

### PRIORITY

This application claims priority to provisional application 60/599,069, with filing date Aug. 6, 2004.

### FIELD OF THE INVENTION

This patent application relates to compositions that can be marked by having laser radiation impinging upon them. The invention is also related to methods for carrying out such marking.

### BACKGROUND OF THE INVENTION

Laser marking is a well known and important means for quickly and cleanly inscribing plastic surfaces with permanent informational indicia marks, such as date codes, batch codes, bar codes or part numbers, functional marks, such as computer keyboard and electronic keypad characters, and decorative marks, such as company logos. As used in the context of the invention, the term “indicia” refers to any laser mark whatsoever including, but not limited to, alphabetical characters, numbers, drawings, patterns, and the like.

A light, dark or colored laser mark on a thermoplastic material may be produced by several different mechanisms or combination of mechanisms, depending on the resin and additives employed, the nature of any colored pigments, and the laser energy characteristics. For example, using a pulsed TEA-CO₂ (Transversal Excited Atmospheric Pressure carbon dioxide) laser, a dark marking on polyethylene containing an energy absorbing pigment (Afflair.RTM. Lustre Pigment, EM Industries, Hawthorne, N.Y.) can be produced at a relatively low energy level (3 joules/cm²) by heat-induced carbonization of the polymer and/or the pigment at the polymer matrix. A continuous wave (CW)-CO₂ laser, however, does not produce sufficient energy to cause carbonization and the plastic melts without leaving a contrast mark. Polymers that have no or a low tendency to carbonize, such as polyolefins and high density polyethylene (HDPE), may show a light mark caused by foaming of the resin due to the heat produced by the laser energy, whereas other polymers, such as polycarbonate (PC), ABS and polystyrene, have a tendency to carbonize rather than foam. A light or a colored mark on a dark background may also be produced when a dark colored additive, such as carbon black or a dark color pigment, is combined with a resin and exposure to the laser results in vaporization or bleaching of the additive and exposure of an underlying heat-stable color pigment or dye or natural polymer color. A dark marking has also been achieved by the use of additives that are colorless in the visible light spectrum but which change into a visible dark or black product when irradiated by laser light just outside the visible range, such as by a Nd:YAG (Neodymium doped Yttrium Aluminum Garnet) laser (wavelength 1064 nm) or an excimer laser (wavelength 308 nm or 351 nm).

Enhancement of the markability of polymers has been achieved by a number of means. For example U.S. Pat. Nos. 5,053,440 and 5,489,639 describe the use of copper salts to absorb laser energy. Similarly, U.S. Pat. No. 5,075,195 discloses the use of a molybdenum salt. Similarly U.S. Pat. No. 5,578,120 discloses the use of inorganic additives.

Specific polymers also have additives disclosed as enhancers of markability. U.S. Pat. No. 5,576,377 discloses specific polymers with pigments that enhance markability. Polyesters with hydrated zinc phosphate is disclosed in U.S. Pat. No. 5,866,644.

Coloring agents are also known enhancers of markability, as disclosed for example in the other references quoted herein, and in U.S. Pat. No. 5,599,869.

The markability of a product can also be enhanced by the use of multilayered structures, and these are described in U.S. Pat. No. 5,831,661, U.S. Pat. No. 6,541,189 and U.S. Pat. No. 6,749,933.

Finally, the use of bulk foamable polymer is also known, as in U.S. Pat. No. 5,977,514, where the use of mica, a colorant, and a foamable polymer is disclosed. U.S. Pat. No. 4,769,257 and U.S. Pat. No. 4,933,205 also describe the use of a substrate that is already foamed.

The present invention is related to the production of a laser markable polymer that comprises inexpensive additives and has utility in industrial and commercial fields in which indicia are required to be imprinted on the surface of a polymer.

### BRIEF DESCRIPTION OF THE INVENTION

The present inventors have discovered that it is possible to enhance the contrast produced by laser radiation impinging on a polymer by adding a small amount of a blowing agent to the polymer, where the amount of blowing agent relative to the amount of polymer in the formulation is less than would normally be required to produce foamability in the polymer. The invention has utility in improving the appearance and usefulness of indicia that are produced with laser plus polymer systems that would otherwise not provide sufficient contrast from the marking process.

The present invention is therefore distinct and novel compared to those described in U.S. Pat. No. 5,977,514, where the use of a foamable polymer is disclosed. U.S. Pat. No. 4,769,257 and U.S. Pat. No. 4,933,205 also describe the use of a substrate that is already foamed. The inventions of these references require that the polymer be either already foamed in bulk before the impingement of the laser energy on the polymer surface or that they be foamable in bulk. The present invention is for a composition that is not foamable in bulk, but comprises a level of foaming agent that is below that which would be required to render the polymer foamable.

In a preferred embodiment of the product of the invention, the product comprises a polymer and a blowing agent at a level of 0.5% or less by weight of polymer. In a still further preferred embodiment of the invention the product comprises a polymer and a blowing agent at a level of less than 0.3% by weight of polymer.

In a further embodiment of the product of the invention, the product comprises one or more additives selected form the group consisting of one or more antixodants, one or more pigments, one or more light stabilizers, one or more fillers, one or more dyes, and any combination thereof.

### DETAILED DESCRIPTION OF THE INVENTION

### DEFINITIONS

As used herein the terms “foaming agent” and blowing agent” are synonymous. As are the terms “blowing” and “foaming”. The composition of the present invention comprises a blowing agent. Normally a blowing agent decomposes above a certain temperature thereby releasing gas, such as nitrogen, which causes a volume increase of the reaction mass. The temperature at which the blowing agent starts decomposing is further referred to as the activation temperature. In principle, any known blowing agent may be used. Generally known blowing agents are for instance sodium bicarbonate, azodicarbonamide-based compound and diphenyloxide-4,4′-disulphohydrazide. The latter is commercially available under the trade mark GENITRON OB, while the azodicarbonamide-based compounds are commercially available under the trade mark GENITRON EPE, EPA and EPB. Also suitable for the present invention is the blowing agent is p-toluene Sulfonyl Semicarbazide (Blo Foam RA).

By “bulk foamabiilty” is meant the ability of the composition to be converted into a foam upon processing at a temperature at or above the activation temperature of the blowing agent. A “bulk foam” refers to a structure in which the final processed morphology of the composition comprises a cellular structure with cells that contain gas. Typically the gas is air, nitrogen or carbon dioxide. The composition of the invention further comprises a polymer and a blowing agent in which the level of the blowing agent in the composition relative to that of the polymer is below what would normally be used to impart bulk foamability to the composition, which is typically 0.5% or more by weight of polymer.

In an embodiment of the invention, a level of less than 0.5% by weight of blowing agent is incorporated into the composition. In a further embodiment of the invention, a level of less than 0.3% of blowing agent is incorporated into the composition.

By filler is meant a compound that is added to a polymer to modify the properties in some desirable way. Fillers are commonly known to those skilled in the art and can include, but are not limited to, mica, calcium carbonate, glass fiber, wood fiber and powder, and talc.

By a “vulcanizable copolymer” is meant a polymer with unsaturation that is capable of being cross linked under appropriate reaction conditions. An example without limitation would be a copolymer of ethylene or propylene with butadiene.

The products of the invention can suitably be prepared according to procedures well known to those skilled in the art such as extrusion and melt blending. Examples of apparatus which may be used to prepare the compounds of the present invention include, but are not limited to, single or multiple screw extruders, mixing rollers, Brabender internal mixers, Banbury mills, and kneaders. For example, the compounds of the present invention may be prepared by feeding ingredients either partly or fully as a pre-blend or separately in a discontinuous or continuous mixer, preferably a continuous mixer. If first compounds are produced not containing a blowing agent then, more preferably, a twin-screw extruder, in particular a co-rotating twin-screw extruder is used.

In one embodiment of the method of the invention, preferably, the compound ingredients are pre-blended as follows. First the polymer is blended with part or, preferably, all of the blowing agent. The blowing agent and polymer may be blended by contacting the blowing agent and polymer and rolling, tumbling or mixing in suitable apparatus. Alternatively, the polymer and blowing agent may be melt mixed using apparatus such as single or multiple screw extruders, mixing rollers, Brabender internal mixers, Banbury mills, and kneaders. When blending of polymer and blowing agent is conducted in an extruder the blowing agent is typically metered into the extruder such that the metering rate is matched to the proportion of blowing and polymer desired in the final compound.

The blended polymer is then molded under conditions of heat shear and pressure that will be familiar to one skilled in the art into articles of use.

The polymer composition of the invention may optionally comprise about 0.001% to about 60% by weight of a filler. In each of the methods and compositions of the invention, the plastic articles suitable for laser marking include any plastic articles that are molded, extruded or formed by any known conventional method. The plastic articles may comprise resins, laser energy absorbing additives and coloring agents, as described above, and may further comprise other additives provided the additives do not interfere with the laser marking of the articles. Such other additives are known to those skilled in the art of polymer compounding and include, but are not limited to, reinforcing fillers, flame retardants, antioxidants, dispersants, impact modifiers, ultraviolet stabilizers, plasticizers, and the like.

Polymer resins suitable for use in this embodiment of the invention include thermoplastic, thermosetting, addition and condensation polymers. Illustrative examples include, but are not limited to, polyolefins, including copolymers of polyethylene and polypropylene, and blends thereof, thermoplastic polyolefins, including block copolymers of polyethylene with ethylene propylene rubber and blends of polyethylene with rubber, polyesters, polystyrene, high impact polystyrene, styrene-butadiene copolymers, impact modified styrene-butadiene copolymer, poly-.alpha.-methyl styrene, styrene acrylonitrile copolymers, acrylonitrile butadiene copolymers, polyisobutylene, polyvinyl chloride, polyvinylidene chloride, polyvinyl acetals, polyacrylonitrile, polyacrylates, polymethacrylates, polymethylmethacrylates, polybutadiene, ethylene vinyl acetate, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polybutylene terephthalate, polyarylates, polyarylene sulfides, polyether ketones, polyethylene, high density polyethylene, polypropylene, and copolymers, grafts, blends, and mixtures thereof. The copolymers and blends of these polymers are well known to those skilled in the relevant technology, as are polymers which may serve as a backbone or a grafted polymer in graft polymers.

In a further embodiment of the invention the blend of polymer and blowing agent, with optional pigments, fillers and additives is subjected to laser irradiation in locations on the surface where it is desired to place patterns or indicia. Sufficient laser power is employed to produce the desired markings on the polymer surface.

It is well known that there are polymers that readily absorb laser energy from lasers, such as Nd:YAG, CO₂ or excimer lasers, without the addition of laser energy absorbing additives. Illustrative examples of such laser energy absorbing polymers are polyvinyl chloride, polyethylene terephthalate, ABS, and the like. Thus, in another embodiment, the invention provides a molded, extruded or formed plastic article having a laser marked indicia thereon and having a composition that comprises (i) about 50% to about 99% by weight of a thermoplastic or a thermosetting resin that absorbs laser energy, and (ii) less than about 0.5% of a foaming agent at a level that is not sufficient to induce bulk foamability in the plastic article . This composition may optionally further contain zero to about 10% by weight of a lubricating agent, zero to about 5% by weight of a darkening pigment, and zero to about 60% by weight of an inert filler, as well as other additives that do not interfere with the absorption and emission of light from the phosphorescent phosphor pigment and the laser marking of the resulting plastic article. Such additives can include antioxidants and light stabilizers.

Useful polymers that readily absorb laser energy without the addition of a laser energy absorbing additive are known to those skilled in the relevant technology and are suitable for use in this embodiment of the invention. Such polymers include, but are not limited to, addition and condensation polymers selected from polyesters, polystyrene, high impact polystyrene, styrene-butadiene copolymers, impact modified styrene-butadiene copolymer, poly-.alpha.-methyl styrene, styrene acrylonitrile copolymers, acrylonitrile butadiene copolymers, polyisobutylene, polyvinyl chloride, polyvinylidene chloride, polyvinyl acetals, polyacrylonitrile, polyacrylates, polymethacrylates, polymethylmethacrylates, polybutadiene, ethylene vinyl acetate, polyamides, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polybutylene terephthalate, polyarylates, polyarylene sulfides, polyether ketones, and, copolymers, grafts, blends and mixtures thereof.

In another embodiment of the invention, when the resin is itself laser energy absorbing, the method for producing a laser marked indicia on a molded, extruded or formed plastic article comprises the steps of compounding a polymeric composition that comprises (i) about 50% to about 99% by weight of a thermoplastic or a thermosetting resin that absorbs laser energy, and (ii) about 1% to about 50% by weight of a pigment; molding, extruding or forming the compounded composition to form a plastic article; and exposing a portion of the plastic article to laser energy from a laser to inscribe an indicia thereon. In each of the above embodiments, the composition preferably further comprises about 0.1% to about 10% of a lubricating agent. The pigment can include carbon black or any organic or inorganic pigment or dye, but in particular dark pigments such as dark reds, blues, greens and purples and any combination thereof.

In the methods of the invention, any pulsed laser that has readily adjustable variable parameters that govern laser energy characteristics, such as pulse content, pulse duration and pulse frequency, may be employed. Preferably, the laser has a wavelength in the near infrared (780 nm to 2000 nm), the visible range (380 nm to 780 nm), or the near ultraviolet range (150 nm to 380 nm). Suitable lasers include, but are not limited to, solid state pulsed lasers, pulsed metal vapor lasers, excimer lasers and continuous wave lasers with pulse modification, such as the commercially available Nd:YAG laser (wavelength 1064 nm), frequency-doubled Nd:YAG laser (wavelength 532 nm) and excimer laser (wavelength 193 nm-351 nm). The laser scanning velocity may range from about 150 to 350 mm/second and the pulse frequency from about 0.1 Hz to 10 kHz. Preferably, the pulse frequency is 1 to about 15 kHz for the Nd:YAG laser and 0.1 to about 200 Hz for the excimer laser. The amperage ranges preferably from 1 to about 20 amperes for the Nd:YAG laser.

### EXAMPLES

For each formulation, all ingredients were added to a container and then tumble-blended for 10 minutes to ensure homogeneity. Table 1 is the formulation list. (EBS=ethyl bis stearamide, Blo Foam RA is p-toluene sulfonyl semicarbazide, supplier.) All materials were processed on a Davis-Standard 32 mm twin-screw extruder.

TABLE 1

| Sample | |
|---|---|
| # | Sample Description |
| 1 | 25% talc-filled polypropylene with .1% Blo-Foam RA |
| 2 | 25% talc-filled polypropylene with .25% Blo-Foam RA |
| 3 | 25% talc-filled polypropylene with .4% Blo-Foam RA |
| 4 | 25% talc-filled polypropylene with 1.5% Crodamide EBS |
| 5 | 25% talc-filled polypropylene with 1.0% Crodamide EBS |
| 6 | 25% talc-filled polypropylene with .75% Crodamide EBS |
| 7 | 25% talc-filled polypropylene with .5% Crodamide EBS |
| 8 | 25% talc-filled polypropylene with 1.0% Licolub FA 1 |

After each sample was pelletized on the twin-screw extruder, 2″×3″ plaques were molded on an Arburg Allrounder 221 E/221 P injection molder.

Formulations according to the compositions in table 1 were extruded in a Davis Standard 32 mm extruder. Extruder temperature for the formulations that contained blowing agent were kept below the stated decomposition temperature of the blowing agent. The resulting melt strands were pelletized and the resulting pellets used as feedstock to an injection molder in which plaques were molded.

Plaques of each formula were laser-etched using an YAG laser (90 Waft Insignia with 12″ lens). The results of each formula are summarized in table 2. The contrast of the resulting etchings were judged subjectively by comparing pairs of plaques. Two technicians gave independent judgments of the etch contrast on a scale of 0-10, with 0 being no visible etch and 10 being a pure while on black appearance. Table 2 summarizes the results.

Each plaque was evaluated for contrast on a scale of 1 to 10, with 1 being no contrast at all and 10 being maximum contrast attainable (e.g., bright white against a black background).

TABLE 2

| Sample # | Visual Contrast Rating (1-10) |
|---|---|
| 1 | 5 |
| 2 | 5 |
| 3 | 5 |
| 4 | 7 |
| 5 | 6 |
| 6 | 4 |
| 7 | 3 |
| 8 | 3 |

Samples 1,2, and 3 with low levels of blowing agent yield higher contrast than the control sample 8.

Sample numbers 4,5 and 6 yield higher contrast but the ethyl-bis-stearamide (EBS) negatively effects the polymer properties. For example, PP containing EBS takes longer time to set up in the mold resulting in longer cycle time and ejector-pin marks, both effects are undesirable. The ddition of EBS based lubricants also softened the material which results in low scratch and mar resistance.

While the invention has been described herein with reference to certain specified embodiments, it is to be understood that it is not intended to limit the invention to the specific forms disclosed. On the contrary, it is intended to cover all modifications and alternative forms falling within the spirit and scope of the invention.

We claim:

1.) a composition capable of being etched by laser radiation comprising;
a polymer,
an internal blowing agent, and optionally,
an additive selected from the group consisting of one or more antioxidants,
one or more pigments, one or more light stabilizers, one or more fillers,
one or more dyes, and any combination thereof,
in which the internal blowing agent is present at a level below that required to make the composition foamable in bulk:

2.) The composition of claim 1 in which the internal blowing agent is selected from the group consisting of sodium bicarbonate, an azodicarbonamide-based compound, and diphenyloxide-4,4′-disulphohydrazide.

3.) The composition of claim 1 in which the internal blowing agent is p-toluene sulfonyl semicarbazide.

4.) The composition of claim 1 in which the blowing agent is present at a level of less than 0.5% by weight of the total.

5.) The composition of claim 1 in which the polymer is selected from the group consisting of polyolefins, polyesters, polystyrene, high impact polystyrene, styrene-butadiene copolymers, impact modified styrene-butadiene copolymer, poly-.alpha.-methyl styrene, styrene acrylonitrile copolymers, acrylonitrile butadiene copolymers, polyisobutylene, polyvinyl chloride, polyvinylidene chloride, polyvinyl acetals, polyacrylonitrile, polyacrylates, polymethacrylates, polymethylmethacrylates, polybutadiene, ethylene vinyl acetate, polyamides, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers, polyethylene terephthalate, polybutylene terephthalate, polyarylates, polyarylene sulfides, polyether ketones, and copolymers, grafts, blends and mixtures thereof.

6.) The composition of claim 1 in which the pigment is selected from the group consisting of carbon black, a green pigment, a red pigment, a blue pigment, an organic pigment, an inorganic pigment and any combination thereof.

7.) The composition of claim 1 in which the filler is selected from the group consisting of mica, calcium carbonate, talc, wood fiber, wood powder, glass fiber, and any combination thereof.

8.) The composition of claim 1 in which the polymer is selected from the group consisting of polyethylene, a block copolymer of polyethylene and polypropylene, a random copolymer of polyethylene and polypropylene, a blend of polyethylene with a random copolymer of polyethylene and polypropylene, a block copolymer of polyethylene with a random copolymer of polyethylene with polypropylene, a blend of polypropylene with a vulcanizable copolymer, a blend of polypropylene with a random copolymer of polyethylene and polypropylene, and a block copolymer of polypropylene with a random copolymer of polyethylene with polypropylene.

9.) A method for etching a polymer sample comprising of the steps of;
providing a polymer composition,
providing a laser source,
irradiating the polymer composition with laser radiation from the laser source,
in which the polymer composition comprises;
a polymer,
a pigment and,
an internal blowing agent, and optionally,
an additive selected from the group consisting of antioxidants, light
stabilizers, fillers, dyes, and any combination thereof,
in which the internal blowing agent is present at a level below that required to make the composition foamable in bulk,
and in which the laser radiation is focused on a region of the polymer composition to be etched.

10.) The method of claim 9 in which the laser is selected from the group consisting of Nd:YAG lasers having principal wavelength of 1,064 nm or 532 nm, solid state pulsed lasers, pulsed metal vapor lasers, excimer lasers, TEA-CO.sub.2 lasers, continuous wave (CW) CO.sub.2 lasers, ruby lasers, and diode lasers.
